(19) United States
(12) Patent Application Publication
(10) Pub. No.: US 2025/0137079 A1
(43) Pub. Date: May 1, 2025

(54) PROCESSING IRON-CONTAINING FEEDSTOCKS USING OXALATE

(71) Applicant: FORM ENERGY, INC., Somerville, MA (US)

(72) Inventors: Alex LUYIMA, Burlignton, MA (US); Joseph Stephen MANSER, Somerville, MA (US)

(21) Appl. No.: 18/906,722

(22) Filed: Oct. 4, 2024

Related U.S. Application Data
(60) Provisional application No. 63/593,491, filed on Oct. 26, 2023.

(51) Int. Cl. C21B 13/00; C01G 49/02

(52) U.S. Cl. CPC C21B 13/00; C01G 49/02

(57) ABSTRACT

The present disclosure is directed to processing iron-containing feedstocks using oxalic acid to cost-effectively and cleanly transform low-cost iron feedstocks into iron-containing products (e.g., metallic iron and/or iron oxide) of high purity. In general, the methods of production using the systems described herein may include leaching low-purity iron feedstocks using a lixiviant including oxalic acid and an iron-complexing additive. The iron-complexing additive may suppress formation of iron (II) oxalate crystals and iron (III) oxalate crystals as leaching of a low-purity iron feedstock is carried out using oxalic acid, thus improving process kinetics and increasing the amount of iron that goes into solution during the leaching operation and ultimately recovered as a high-purity iron-containing product (e.g., metallic iron and/or iron oxide).

### CROSS-REFERENCE TO RELATED APPLICATIONS

This application claims the benefit of priority to U.S. Provisional Patent Application 63/593,491, filed Oct. 26, 2023, the entire contents of which are hereby incorporated herein by reference.

### BACKGROUND

Iron-based batteries, such as iron-air, iron-nickel, and iron-manganese oxide batteries, are promising candidates for long-duration energy storage due to the low cost and high abundance of iron. Generally, the lowest-cost iron materials are those of low purity and associated with a large percentage of global carbon dioxide emissions. This is in tension with the general requirements of batteries, which often require high purity input materials to reduce efficiency losses and degradation caused by impurities (e.g., as a result of catalysis of unwanted side reactions) while also being useful as storage for clean energy sources. Accordingly, there remains a need for low-cost iron materials that are of high purity and cleanly produced while supporting robust performance of iron-based batteries.

### SUMMARY

The present disclosure is directed to processing iron-containing feedstocks using oxalic acid to cost-effectively and cleanly transform low-cost iron feedstocks into iron-containing products (e.g., metallic iron and/or iron oxide) of high purity. In general, the methods of production using the systems described herein may include leaching low-purity iron feedstocks using a lixiviant including oxalic acid and an iron-complexing additive. The iron-complexing additive may suppress formation of iron (II) oxalate crystals and iron (III) oxalate crystals as leaching of a low-purity iron feedstock is carried out using oxalic acid, thus improving process kinetics and increasing the amount of iron that goes into solution during the leaching operation and ultimately recovered as a high-purity iron-containing product (e.g., metallic iron and/or iron oxide).

According to one aspect, a method of hydrometallurgical processing may include dissolving at least one component of an iron-containing feedstock in a lixiviant in a leaching reactor, the at least one component dissolved in the lixiviant forming a leaching slurry, the lixiviant including oxalate and an iron-complexing additive, separating the leaching slurry into insoluble solids and a pregnant leaching solution, precipitating iron (II) oxalate crystals from the pregnant leaching solution in a precipitation reactor, and recovering an iron-containing product from the iron (II) oxalate crystals in a recovery reactor.

In certain implementations, the iron-containing feedstock may include iron-bearing tailing, iron-bearing residue, mill scale, or a combination thereof. For example, the iron-containing feedstock may include red mud, pyrrhotite, or a combination thereof.

In some implementations, the iron-containing feedstock may include iron ore. For example, the iron ore may include one or more of hematite, magnetite, ferrihydrite, or goethite.

In certain implementations, the iron-containing feedstock may include iron oxide, iron hydroxide, iron oxyhydroxide, metallic iron, or a combination thereof.

In some implementations, the oxalate may include oxalic acid. For example, the oxalic acid may have 0.5-6 mol/L concentration in the lixiviant. Further, or instead, the lixiviant may include oxalic-hydrochloric acid or oxalic-hydrochloric-hydrogen peroxide.

In certain implementations, the oxalate may have a concentration of greater than 1 mol/L in the lixiviant and separating the leaching slurry into the insoluble solids and the pregnant leaching solution includes filtering the leaching slurry at a temperature of 65° C.-100° C. and then diluting the pregnant leaching solution. For example, diluting the pregnant leaching solution may include cooling the leaching slurry to a temperature greater than about 20° C. and less than about 30° C. to separate oxalic acid crystals from the pregnant leaching solution and directing the pregnant leaching solution to the precipitation reactor. In certain instances, separating the oxalic acid crystals from the pregnant leaching solution may include recycling the oxalic acid crystals to the lixiviant in the leaching reactor.

In some implementations, the oxalate may include salt of oxalic acid.

In certain implementations, dissolving the at least one component of the iron-containing feedstock in the lixiviant may include maintaining oxidation-reduction potential of the lixiviant within a predetermined range in the leaching reactor. As an example, the predetermined range may favor formation of iron (II)-complexes and iron (III)-complexes. In certain instances, the predetermined range may be 0.5-1.7 V versus standard hydrogen electrode (SHE). Maintaining the oxidation-reduction potential of the lixiviant within the predetermined range in the leaching reactor may include introducing an oxidant into the leaching reactor. For example, the oxidant may include hydrogen peroxide, sodium hypochlorite, or a combination thereof. In certain instances, introducing the oxidant into the leaching reactor may include bubbling oxygen or air through the lixiviant in the leaching reactor such that the oxidant includes oxygen.

In some implementations, dissolving the at least one component of the iron-containing feedstock in the lixiviant may include introducing scrap iron into the leaching reactor.

In certain implementations, the lixiviant may have a pH less than 1.

In some implementations, the iron-complexing additive may include a chloride salt, hydrochloric acid, or a combination thereof. For example, the chloride salt may include sodium chloride (NaCl), magnesium chloride (MgCl2), calcium chloride (CaCl2), zinc chloride (ZnCl2), and combinations thereof.

In certain implementations, the iron-complexing additive may include a citric acid and/or a citrate salt.

In some implementations, dissolving the at least one component of the iron-containing feedstock in the lixiviant may include mixing the iron-containing feedstock and the lixiviant together in the leaching reactor. As an example, mixing the iron-containing feedstock and lixiviant together may include forming the leaching slurry having 4-55 mL of oxalic acid per gram of iron-containing feedstock. In certain instances, dissolving the at least one component of the iron-containing feedstock in the lixiviant may include mixing the iron-containing feedstock and the lixiviant together for greater than about 1 hour and less than about 72 hours.

In certain implementations, the oxalate in the lixiviant may be 10-35 percent above a stoichiometric amount of the oxalate with respect to iron in the iron-containing feedstock.

In some implementations, dissolving the at least one component of the iron-containing feedstock may include reducing the iron-containing feedstock to a particle size distribution with d80 about 20 microns and less than about 150 microns.

In certain implementations, dissolving at least one component of the iron-containing feedstock may include grinding the iron-complexing additive and the iron-containing feedstock together.

In some implementations, dissolving the at least one component of the iron-containing feedstock may include oxidizing one or more components of the iron-containing feedstock. For example, oxidizing the one or more components of the iron-containing feedstock may include oxidizing iron sulfides and carbon in the iron-containing feedstock. Further, or instead, oxidizing the one or more components of the iron-containing feedstock may include treating the iron-containing feedstock with bacteria that consumes carbon and sulfur. In certain instances, oxidizing the one or more components of the iron-containing feedstock may include washing chlorides from the iron-containing feedstock before treating the iron-containing feedstock with the bacteria.

In certain implementations, the at least one component of the iron-containing feedstock may be dissolved in the lixiviant at a temperature greater than about 70° C. and less than about 100° C.

In some implementations, dissolving the at least one component of the iron-containing feedstock in the lixiviant may include shielding penetration of visible light and/or ultraviolet light into the leaching reactor.

In certain implementations, dissolving the at least one component of the iron-containing feedstock may include introducing scrap iron and/or an iron (II) salt to the iron-containing feedstock.

In some implementations, separating the leaching slurry into the insoluble solids and the pregnant leaching solution may include pumping the leaching slurry from the leaching reactor toward the precipitation reactor.

In certain implementations, the insoluble solids may include silicon dioxide.

In some implementations, precipitating iron (II) oxalate crystals may include controlling pH of the pregnant leaching solution to a range favoring iron (II) oxalate precipitation. For example, controlling pH of the pregnant leaching solution may include introducing sodium bisulfite (NaHSO₃), sugar, wood, or a combination thereof into the pregnant leaching slurry in the precipitation reactor.

In certain implementations, the oxalate may have a concentration of 1 mol/L or less in the lixiviant. As an example, separating the leaching slurry into the insoluble solids and the pregnant leaching solution may include filtering the insoluble solids from the pregnant leaching solution at a temperature greater than about 20° C. and less than about 30° C.

In some implementations, separating the leaching slurry into the insoluble solids and the pregnant leaching solution may include diluting the leaching slurry with water to form a diluted slurry and filtering the diluted slurry to separate the insoluble solids from the pregnant leaching solution.

In certain implementations, precipitating the iron (II) oxalate crystals from the pregnant leaching solution may include exposing the pregnant leaching solution to ultraviolet light while stirring the pregnant leaching solution in the precipitation reactor.

In some implementations, precipitating the iron (II) oxalate crystals from the pregnant leaching solution may include separating the iron (II) oxalate crystals from raffinate. As an example, separating the iron (II) oxalate crystals from the raffinate may include recycling the raffinate to the precipitation reactor and/or to the leaching reactor.

In certain implementations, recovering the iron-containing product from the iron (II) oxalate crystals may be carried out at a temperature of greater than about 400° C. and less than about 800° C. at atmospheric pressure in the recovery reactor. For example, recovering the iron-containing product may include reducing the iron (II) oxalate crystals to metallic iron. In certain instances, reducing the iron (II) oxalate crystals to the metallic iron may be carried out in a reducing environment in the recovery reactor. In certain instances, the reducing environment may include hydrogen. In some instances, reducing the iron (II) oxalate crystals to the metallic iron may include forming particles of the metallic iron from agglomerations of the iron (II) oxalate crystals. As an example, the agglomerations of the iron (II) oxalate crystals may include a binder. In some cases, recovering the iron-containing product from the iron (II) oxalate crystals in the recovery reactor may include decomposing the iron (II) oxalate crystals to iron (II) oxide. The iron (II) oxalate crystals may be decomposed to iron (II) oxide in an inert environment in the recovery reactor. For example, the inert environment may include nitrogen and/or argon in the recovery reactor.

In some implementations, the iron-containing feedstock may include refractory iron ore. For example, dissolving the at least one component of the iron-containing feedstock in the lixiviant in the leaching reactor may have an extraction efficiency of at least 60 percent with respect to the refractory iron ore.

In certain implementations, the method may further, or instead, include forming the oxalate using biofermentation of glucose, synthesis from carbon dioxide and hydrogen, or a combination thereof.

### DESCRIPTION OF THE DRAWING

FIG. 1 is a block diagram of a system for processing iron-containing feedstock, the system including a leaching reactor, a separation reactor, a precipitation reactor, and a recovery reactor.

FIG. 2A is a graph of variation of concentration (mol/L) of dissolved and crystallized iron as a function of oxalic acid concentration in thermodynamic simulation results of oxalic acid leaching of a generic hematite iron ore feedstock (0.20 mol/L Fe2O3, 0.017 mol/L Fe3O4, and 0.0045 mol/L FeOOH) at 98° C., 1 atm, without addition of chloride.

FIG. 2B is a graph of variation of concentration of dissolved and crystallized iron as a function of oxalic acid concentration in thermodynamic simulation results of oxalic acid leaching of the generic hematite iron ore feedstock of FIG. 2A under the same conditions as the simulation shown in FIG. 2A, except with the addition of 0.6845 mol/L sodium chloride to the feedstock.

FIG. 3A is a graph of iron (III) oxalate concentration as a function of oxalic acid concentration in thermodynamic simulation results of varying amounts of sodium chloride in oxalic acid leaching of the generic hematite iron ore feedstock of the simulations shown in FIGS. 2A and 2B, under the same conditions as the simulations in FIGS. 2A and 2B.

FIG. 3B is a graph of iron (II) oxalate concentration as a function of oxalic acid concentration in thermodynamic simulation results of varying amounts of sodium chloride in oxalic acid leaching of generic magnetite (0.406 mol/L FeO, 0.017 mol/L Fe3O4, 0.0045 mol/L FeOOH) at 98° C. and 1 atm.

FIG. 4A is a Pourbaix diagram of stable species determined through thermodynamic simulation in which 0.406 moles/L of iron ore containing 100% wustite phase is leached in 2 mol/L oxalic acid at 98° C. in a leaching reactor.

FIG. 4B is a graph of concentration of dissolved and crystallized iron as a function of varying oxygen concentration in thermodynamic simulation results of the leaching reactor of FIG. 4A under otherwise identical conditions as used in the thermodynamic simulations shown in FIG. 4A.

FIG. 4C is a Pourbaix diagram of stable species determined through thermodynamic simulation results of the leaching reactor of FIG. 4A under otherwise identical conditions as used in the thermodynamic simulations shown in FIG. 4A, except with 0.05 mol/L oxygen concentration in the leaching reactor.

Like reference symbols in the various drawings indicate like elements.

### DETAILED DESCRIPTION

Embodiments will be described in detail with reference to the accompanying drawings, in which exemplary embodiments are shown. The foregoing may, however, be embodied in many different forms and should not be construed as limited to the exemplary embodiments set forth herein. All flows of material described herein may flow through conduits (e.g., pipes and/or manifolds) or other forms of material transport, unless otherwise specified or made clear from the context. Unless otherwise specified or made clear from the context, all fluid flows described herein shall be understood to flow through conduits (e.g., pipes and/or manifolds) represented by various arrows herein.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, the configurations provided in the various embodiments of this specification may be used with each other. For example, the components of an embodiment having A, A′ and B and the components of an embodiment having A″, C and D can be used with each other in various combinations, e.g., A, C, D, and A. A″ C and D, etc., in accordance with the teaching of this disclosure.

As used herein, the term “reactor” is used for the sake of convenience and clarity of description, and shall be understood to include a single volume in which one or more chemical and/or physical processes are carried out, multiple volumes in which single chemical and/or physical process is carried out, and any combination thereof. Thus, for example, any one or more of the various different process steps described herein may be carried out in a volume or in multiple volumes separated from one another, unless otherwise specified or made clear from the context.

As used herein, the term “iron-containing feedstock” shall be understood to be distinguished from “iron-containing product” at least in that iron-containing feedstock is generally used herein to refer to an iron-containing input into a leaching reactor, whereas iron-containing product is generally used to refer to an output of high-purity metallic iron and/or high-purity iron oxide. Thus, unless otherwise specified or made clear from the context, iron-containing feedstock used as raw material for a given process shall be understood to be less pure with respect to metallic iron and/or iron oxide than iron-containing product produced according to the given process.

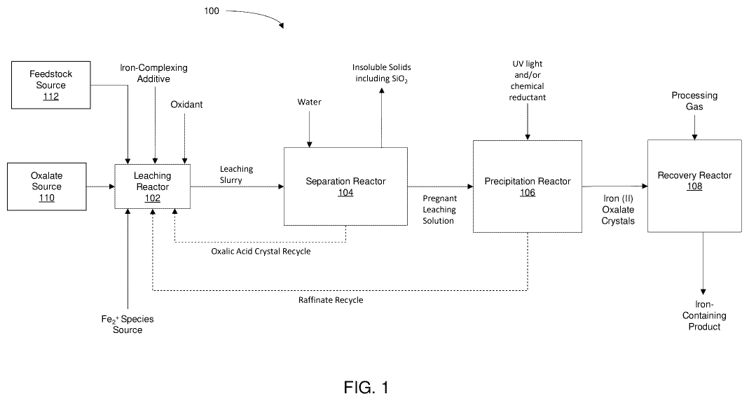

Referring now to FIG. 1, a system 100 may include a leaching reactor 102, a separation reactor 104, a precipitation reactor 106, and a recovery reactor 108. The system 100 may be used for scalable and cost-effective transformation of low-cost iron feedstocks into high-purity iron containing product using oxalate chemistry techniques, described in greater detail below, that are much cleaner and less expensive than producing iron containing products of similar purity using processes reliant upon fossil fuels like coal, coke, and gas. Stated differently, the presently described techniques for producing high-purity iron-containing product using oxalate chemistry may facilitate producing higher-purity iron metal at a given cost and for a given carbon footprint, as compared to production fossil fuel-based production processes that are common in the iron and steel industry. For example, using the system 100, the oxalate chemistry techniques described herein may be carried out at relatively low temperatures compared to fossil fuel-based production of high-purity iron-containing products, thus requiring less energy and/or cost to produce the same amount of a given iron-containing product. Further, or instead, as compared to fossil fuel-based production of high-purity iron-containing product, the oxalate chemistry techniques described herein may be carried out using materials that are abundant and/or producible from sustainable sources, thus offering significant potential for reducing carbon dioxide emissions and/or cost as compared to the use of fossil fuel-based production to produce the same amount of a given iron-containing product.

In use, as also described in greater detail below, the system 100 may carry out techniques to produce iron, via oxalate chemistry, with iron extraction rates suitable for cost-effective, large scale iron production. That is, generally, iron passivates in concentrated oxalic acid solutions. This results in formation of insoluble iron (II) oxalate (FeC₂O₄·2H₂O), which hinders the further dissolution of iron and, therefore, negatively impacts extraction efficiency. Additionally, one of the mechanisms of iron dissolution is reductive-namely, oxalic acid reduces iron (III) (Fe₃⁺) to iron (II) (Fe₂⁺) during reductive dissolution, and this affects the leaching (dissolution) efficiency by formation of insoluble iron (II) oxalate. Accordingly, the techniques described herein for producing iron via oxalate chemistry include suppression of formation of iron (II) oxalate crystals and iron (III) oxalate crystals during dissolution of an iron-containing feedstock to improve process kinetics and increase the amount of iron that goes into solution as part of a leaching process. More specifically, such suppression may be achieved using any one or more of various different iron-complexing additives in a lixiviant used to dissolve an iron-containing feedstock. As an example, the system 100 may carry out the following generalized process steps of hydrometallurgical processing: 1) dissolving an iron-containing feedstock in a lixiviant in the leaching reactor 102, the at least one component dissolved in the lixiviant forming a leaching slurry, and the lixiviant including oxalate and an iron-complexing additive; 2) separating the leaching slurry into insoluble solids and a pregnant leaching solution in the separation reactor 104; 3) precipitating iron (II) oxalate crystals from the pregnant leaching solution in a precipitation reactor 106; and 4) recovering an iron-containing product from the iron (II) oxalate crystals in a recovery reactor 108. Each of these steps are described in the following sections. While these are described separately, it shall be appreciated that this is for the sake of clear and efficient explanation. Thus, unless otherwise specified or made clear from the context, it shall be appreciated that any one or more aspects of the steps described below may be carried out separately and/or together.

### 1. Dissolving Iron-Containing Feedstock to Form a Leaching Slurry

In general, as indicated above, the hydrometallurgical processing techniques carried out by the system 100 may include dissolving at least one component (e.g., at least one iron-containing component) of an iron-containing feedstock in a lixiviant in the leaching reactor 102 such that a leaching slurry is formed in the leaching reactor 102. The lixiviant may include oxalate and an iron-complexing additive. In particular, the oxalate may act as a leaching solvent for dissolving the at least one component of the iron-containing feedstock while the iron-complexing additive may suppress formation of iron (II) oxalate crystals and iron (III) oxalate crystals in the leaching reactor 102, where such crystal formation reduces extraction efficiency of the leaching process and is, thus, undesirable. In some implementations, the oxalate may be directed into the leaching reactor 102 from an oxalate source 110. Additionally, or alternatively, the iron-containing feedstock may be directed into the leaching reactor 102 from a feedstock source 112. The iron-complexing additive may be introduced into the leaching reactor 102 together with the oxalate (e.g., from the oxalate source 110), together with the iron-containing feedstock (e.g., from the feedstock source 112), and/or from an independent process stream. As compared to leaching with the oxalate without the iron-complexing additive, the extraction efficiency (percentage of iron in the iron-containing feedstock that gets dissolved in the lixiviant) of the dissolving process increases to efficiencies that are commercially viable. For example, in instances in which the iron-containing feedstock includes refractory iron ore, dissolving the at least one component of the iron-containing feedstock in the lixiviant may have an extraction efficiency of at least 60 percent with respect to the refractory iron ore.

In certain implementations, the at least one component of the iron-containing feedstock may be dissolved in the lixiviant at a temperature greater than about 70° C. and less than about 100° C. Further, or instead, dissolving the at least one component of the iron-containing feedstock in the lixiviant may include mixing the iron-containing feedstock and the lixiviant together (e.g., for greater than about 1 hour and less than about 72 hours) until the at least one component of the iron-containing feedstock form the leaching slurry with a predetermined composition (e.g., 4-55 mL of oxalic acid per gram of iron-containing feedstock), with the amount of time for forming such a slurry varying according to composition of the iron-containing feedstock. As compared to the much higher temperatures associated with forming iron from fossil fuels, the relatively low temperatures and/or modest mixing energy requirements associated with dissolving the at least one iron-containing feedstock in the lixiviant requires less energy. Further, or instead, dissolving the at least one component of the iron-containing feedstock at these relatively low temperatures and/or with modest mixing energy requirements may be associated with lower capital equipment costs than those associated with forming iron from fossil fuels. Still further, or instead, dissolving the at least one component of the iron-containing feedstock in the lixiviant may include shielding penetration of visible light and/or ultraviolet light into the leaching reactor to reduce the likelihood of precipitation of iron (II) oxalate crystals and/or iron (III) oxalate crystals in the leaching reactor 102. It shall be appreciated that such shielding may be achieved using any one or more of various different types of materials that are opaque relative to visible light and/or ultraviolet light and, thus, does not represent a significant cost.

In general, the oxalate may be in any one or more forms as may be convenient and/or cost-effective for sourcing, handling, and/or producing while maintaining effectiveness in dissolving the at least one component of the iron-containing feedstock. In particular, it shall be appreciated that oxalate is a naturally occurring material derivable, for example, from plants. That is, oxalate is an inexpensive solvent that may also be sustainably sourced, making it a cost effective and clean alternative to other types of solvents for dissolving iron-containing feedstocks. In some implementations, the oxalate may be formed in the oxalate source 110 using one or more sustainable methods, such as biofermentation of glucose, synthesis from carbon dioxide and hydrogen, or a combination thereof.

As an example, the oxalate may include oxalic acid and/or salt of oxalic acid controlled to move from the oxalate source 110 to the leaching reactor 102 such that the oxalate concentration of the oxalate in the lixiviant in the leaching reactor 102 may be controlled to within a predetermined range. For example, the oxalate in the lixiviant may be 10-35 percent above a stoichiometric amount of the oxalate with respect to iron in the iron-containing feedstock. At such a range above the stoichiometric amount, the oxalate may be effective in dissolving all or at least a substantial portion of the at least one component of the iron-containing compound while doing so using cost-effective amounts of the oxalate. In instances in which the oxalate is oxalic acid, the flow of oxalic acid from the oxalate source 110 into the leaching reactor 102 may be controlled such that the oxalic acid has a high concentration (e.g., 0.5-6 mol/L) in the lixiviant in the leaching reactor 102. In some implementations, the lixiviant may have a pH<1.

While the oxalate may be introduced into the lixiviant in the leaching reactor 102 as a separate component in some instances, it shall be appreciated that the oxalate may be combined with one or more components (e.g., in a predetermined ratio) and then introduced into the lixiviant in the leaching reactor 102. For example, while the oxalate from the oxalate source 110, the iron-complexing additive, and/or other additives (e.g., an oxidation-reduction potential (ORP) additive) may be introduced into the leaching reactor 102 separately, it shall be appreciated the oxalate from the oxalate source 110 may be introduced into the leaching reactor 102 as a component in a mixture of components. More specifically, the oxalate from the oxalate source 110 may be combined with the iron-complexing additive and/or other additives, as may be useful for accurately controlling relative ratios of these components in the lixiviant in the leaching reactor 102. As a more specific example, the oxalate may be introduced into the leaching reactor in oxalic-hydrochloric acid, oxalic-hydrochloric-hydrogen peroxide, oxalic-HCl—NaCl, oxalic-NaCl, and/or oxalic NaOCl.

In general, the iron-complexing additive may be any one or more of various different materials useful for suppressing formation of iron (II) oxalate crystals and iron (III) oxalate crystals in the leaching reactor 102. In particular, the iron-complexing additive may generally be an inexpensive material (or combination of materials) that may be safely handled with little or no need for special equipment. As an example, the iron-complexing additive may include a chloride salt, hydrochloric acid, or a combination thereof. For example, the chloride salt may include sodium chloride (NaCl), magnesium chloride (MgCl₂), calcium chloride (CaCl₂)), zinc chloride (ZnCl₂), and combinations thereof. Further, or instead, the iron-complexing additive may include a citric acid and/or a citrate salt.

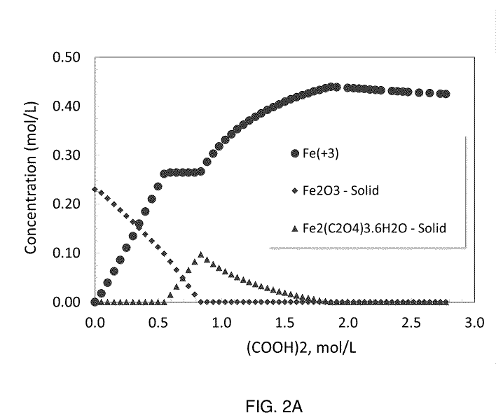

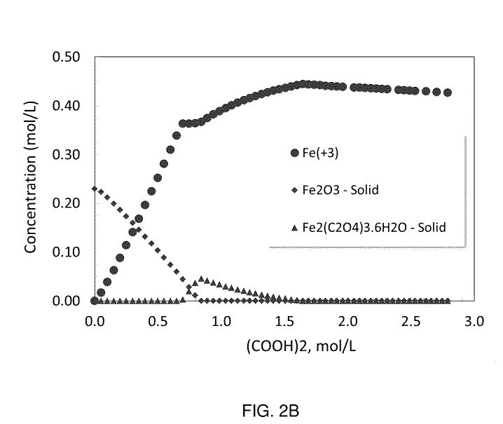

Referring now to FIGS. 2A and 2B, thermodynamic simulations were performed for oxalic acid leaching of generic hematite iron ore feedstock without the addition of chloride (FIG. 2A) and with the addition of 0.6845 mol/L sodium chloride (FIG. 2B). As may be appreciated through comparison of the respective peaks of solid iron (III) oxalate (Fe₂(C₂O₄)₃·6H₂O—solid) in the simulation results in FIGS. 2A and 2B, the addition of a modest amount of sodium chloride is expected to decrease significantly the amount of iron (III) oxalate crystals formed under otherwise identical conditions. Stated differently, the addition of a viable amount of sodium chloride is expected to increase the amount of iron from the iron-containing feedstock that becomes dissolved in a lixiviant including oxalic acid.

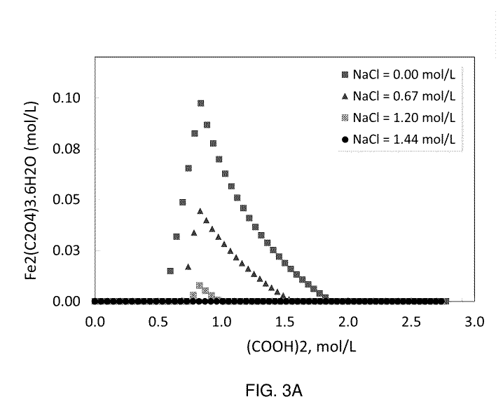

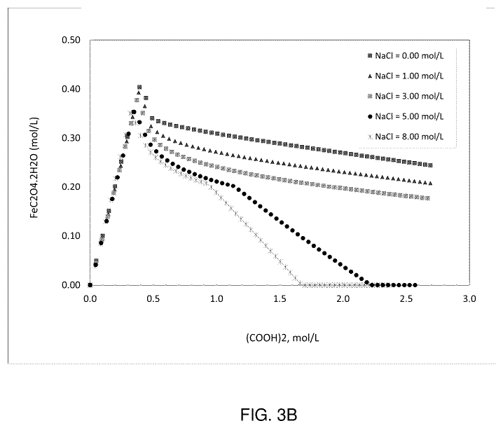

Referring now to FIGS. 3A and 3B, thermodynamic simulations were performed to simulate the impact of varying amounts of sodium chloride on the concentration of iron (III) oxalate (FIG. 3A) over a range of oxalic acid concentration mixed with generic hematite and the impact of varying amounts of sodium chloride on the concentration of iron (II) oxalate (FIG. 3B) over a range of oxalic acid concentration mixed with generic magnetite. Without wishing to be bound by theory, it is believed that the presence of high concentrations of chloride (NaCl in this case) leads to formation of soluble iron chloride complexes and that is what reduces the iron available for iron (II) oxalate crystallization and iron (III) oxalate crystallization.

Referring again to FIG. 1, the iron-containing feedstock may be directed into the leaching reactor 102 from a feedstock source 112. The iron-containing feedstock moving from the feedstock source 112 into the leaching reactor 102 may include any one or more of various different sources of low-cost iron. That is, the processing carried out by the system 100 may be robust to accommodate variations in composition of the iron-containing feedstock according to local conditions. For example, the iron-containing feedstock may include iron ore (hematite, magnetite, ferrihydrite, and/or goethite), iron containing residues and tailings from other base metals processing (e.g., red mud, pyrrhotite, ilmenite processing residues, jarosite residues, drosses, and/or slag from electric arc furnaces), mill scale, hematite from pickling solutions, scrap iron and steel, blue dust, and combinations thereof. Further, or instead, the iron-containing feedstock may include iron oxide, iron hydroxide, iron oxyhydroxide, metallic iron, or a combination thereof.

In certain instances, the iron-containing feedstock may undergo one or more pre-processing operations at the feedstock source 112 to facilitate more effective dissolution of the iron-containing feedstock in the leaching reactor 102. For example, dissolving the at least one component of the iron-containing feedstock may include reducing the iron-containing feedstock (e.g., in the feedstock source 112) to a particle size distribution with d80 about 20 microns and less than about 150 microns, as may be useful for exposing more surface area of the iron-containing feedstock to the lixiviant while maintaining a particle size distribution that is readily movable. Further, or instead, dissolving the at least one component of the iron-containing feedstock may include grinding the iron-containing feedstock and the iron-complexing additive together (e.g., in the feedstock source 112), as may be useful for controlling the ratio of these components relative to one another while increasing the uniformity of distribution of these components relative to one another within the leaching reactor 102. Still further, or instead, dissolving the at least one component of the iron-containing feedstock may include oxidizing one or more components of the iron-containing feedstock (e.g., in the feedstock source 112). As a more specific example, oxidizing the one or more components of the iron-containing feedstock may include oxidizing iron sulfides and carbon in the iron-containing feedstock. In some instances, oxidizing the one or more components of the iron-containing feedstock may include treating the iron-containing feedstock with bacteria that consumes carbon and sulfur, as may be useful reducing energy requirements associated with pre-processing the iron-containing feedstock. As a specific example, oxidizing the one or more components of the iron-containing feedstock may include washing chlorides from the iron-containing feedstock before treating the iron-containing feedstock with the bacteria.

Referring again to FIG. 1, in certain implementations, dissolving the at least one component of the iron-containing feedstock in the lixiviant may include maintaining oxidation-reduction potential of the lixiviant within a predetermined range in the leaching reactor 102. For example, the predetermined range of oxidation-reduction potential may favor formation of iron (II)-complexes and iron (III)-complexes and, in particular, may be 0.5-1.7 V versus standard hydrogen electrode (SHE). As an example, maintaining the oxidation-reduction potential of the lixiviant within the predetermined range in the leaching reactor 102 may include introducing an oxidant into the leaching reactor 102. As a more specific example, the oxidant may include hydrogen peroxide, sodium hypochlorite, or a combination thereof. Further, or instead, introducing the oxidant into the leaching reactor 102 may include bubbling oxygen or air through the lixiviant in the leaching reactor 102 such that the oxidant introduced into the leaching reactor 102 includes oxygen.

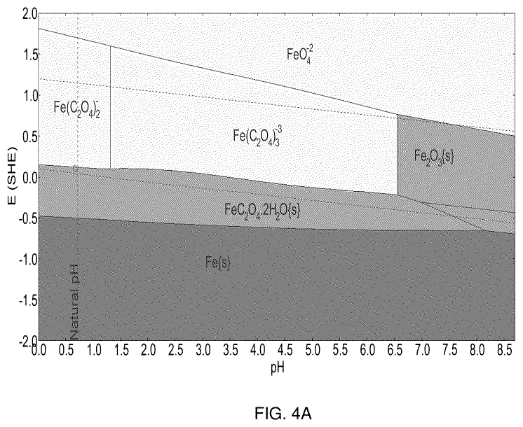

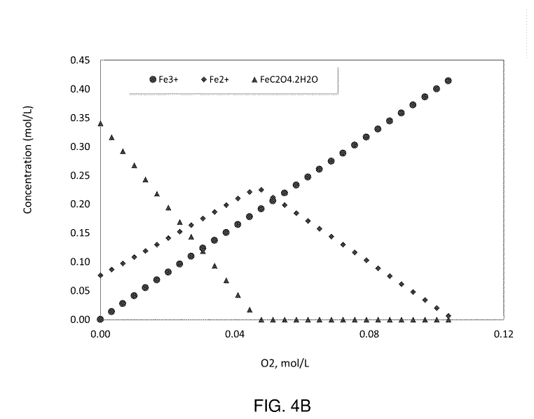

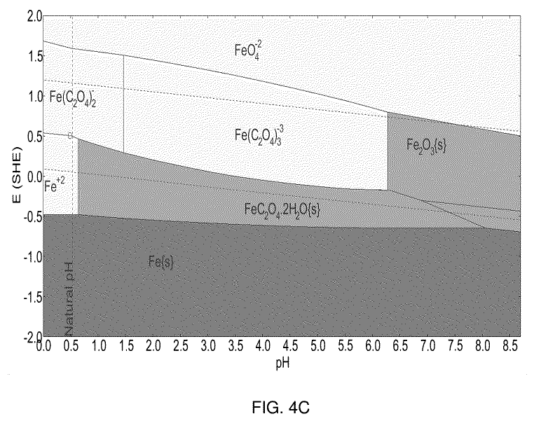

FIG. 4A is a Pourbaix diagram of stable species determined through thermodynamic simulation in which 0.406 moles/L of iron ore containing 100% wustite phase is leached in 2 M oxalic acid at 98° C. in a leaching reactor. In FIG. 4A, the medium grey area represents the range of possible passivation of iron (II) oxalate and iron oxide. In this area, iron ore forms an iron (II) oxalate passivating layer on the surface, which may protect the iron ore from dissolution. The Fe₂⁺ species are formed by both acidic (H⁺) leaching and reductive leaching of oxalic acid. The oxidation reduction potential of the initial lixiviant solution (the circle on the natural pH vertical line) is in the iron (II) oxalate region, which is indicative of potential passivation and low leaching efficiency.

FIG. 4B is a graph of concentration of dissolved and crystallized iron as a function of varying oxygen concentration in thermodynamic simulation results of the leaching reactor of FIG. 4A under otherwise identical conditions as used in the thermodynamic simulations shown in FIG. 4A. As may be appreciated from FIG. 4B, the thermodynamic simulation results suggest that an amount as little as about 0.05 mol/L of oxygen in the lixiviant may have a significant impact on reducing formation of iron (II) oxalate crystals in the lixiviant.

FIG. 4C is a Pourbaix diagram of stable species determined through thermodynamic simulation results of the leaching reactor of FIG. 4A under otherwise identical conditions as used in the thermodynamic simulations shown in FIG. 4A, except with 0.05 mol/L oxygen concentration in the leaching reactor. As may be appreciated from FIG. 4C, oxygen bubbling through the lixiviant reduces crystallization of iron (II) oxalate and, therefore, makes the oxidation reduction potential of the lixiviant in the soluble range.

Referring again to FIG. 1, in certain implementations, a source of Fe₂⁺ species may be added to the process flow (e.g., added to the iron-containing feedstock in the feedstock source 112 as part of pre-processing and/or added to the leaching reactor 102) to increase the rate of iron dissolution in the iron-containing feedstock in the leaching reactor 102. In such instances, while small amounts of a source of Fe₂⁺ species may be useful, it shall be appreciated that large amounts may precipitate iron (II) oxalate and, thus, reduce efficiency. As an example, the source of Fe₂⁺ species may include scrap iron and/or an iron (II) salt, each of which may be cost-effectively sourced.

2. Separating the Leaching Slurry into Insoluble Solids and a Pregnant Leaching Solution

In general, as indicated above, the hydrometallurgical processing techniques carried out by the system 100 may include separating the leaching slurry into insoluble solids (e.g., SiO₂) and a pregnant leaching solution. For example, separating the leaching slurry into the insoluble solids and the pregnant leaching solution may include pumping the leaching slurry from the leaching reactor 102 toward the precipitation reactor 106, via the separation reactor 104, such that the pumping force facilitates separation of the leaching slurry into the insoluble solids and the pregnant leaching solution.

In certain instances, in which the oxalate has a concentration of greater than 1 mol/L in the lixiviant, separating the leaching slurry into the insoluble solids and the pregnant leaching solution in the separation reactor 104 may include filtering the leaching slurry at a temperature of 65° C.-100° C. and then diluting the pregnant leaching solution. Continuing with this example, diluting the pregnant leaching solution may include cooling the leaching slurry to a temperature greater than about 20° C. and less than about 30° C. to separate oxalic acid crystals from the pregnant leaching solution and directing (e.g., pumping) the pregnant leaching solution from the separation reactor 104 to the precipitation reactor 106. In certain instances, separating the oxalic acid crystals from the pregnant leaching solution in the separation reactor 104 may include recycling the oxalic acid crystals to the lixiviant in the leaching reactor 102.

In some instances, in which the oxalate has a concentration of greater than 1 mol/L in the lixiviant, separating the leaching slurry into the insoluble solids and the pregnant leaching solution may include diluting the leaching slurry with water to form a diluted slurry and filtering the diluted slurry to separate the insoluble solids from the pregnant leaching solution. As an example, insoluble solids may be filtered from the pregnant leaching solution at a temperature greater than about 20° C. and less than about 30° C. In instances in which the oxalate has a concentration of 1 mol/L or less in the lixiviant, it shall be appreciated that a similar filtration approaches may be used without the use of dilution.

3. Precipitating Iron (II) Oxalate Crystals from the Pregnant Leaching Solution

In general, as indicated above, the hydrometallurgical processing techniques carried out by the system 100 may include precipitating iron (II) oxalate crystals from the pregnant leaching solution in the precipitation reactor 106. For example, precipitating iron (II) oxalate crystals from the pregnant leaching solution may include controlling pH of the pregnant leaching solution to a range favoring iron (II) oxalate precipitation. As a more specific example, controlling pH of the pregnant leaching solution may include introducing a reductant (e.g., sodium bisulfite (NaHSO₃), sugar, wood, or a combination thereof) into the pregnant leaching slurry in the precipitation reactor 106. Further, or instead, precipitating the iron (II) oxalate crystals from the pregnant leaching solution may include exposing the pregnant leaching solution to ultraviolet light while stirring the pregnant leaching solution in the precipitation reactor 106. Still further, or instead, precipitating the iron (II) oxalate crystals from the pregnant leaching solution may include separating the iron (II) oxalate crystals from raffinate and, in some instances, the raffinate may be recycled to the precipitation reactor 106 and/or to the leaching reactor 102. Further, or instead, the raffinate may be crystallized to recover excess oxalic acid that is then recycled into the leaching reactor 102 as an oxalic acid makeup.

4. Recovering an Iron-Containing Product from the Iron (II) Oxalate Crystals

In general, as indicated above, the hydrometallurgical processing techniques carried out by the system 100 may include recovering an iron-containing product from the iron (II) oxalate crystals in the recovery reactor 108. For example, recovering the iron-containing product from the iron (II) oxalate crystals may be carried out at a temperature of greater than about 400° C. and less than about 800° C. at atmospheric pressure in the recovery reactor 108. Continuing with this example, an environment gas may be introduced into the recovery reactor 108 according to the type of recovery process.

For example, in some instances, recovering the iron-containing product may include reducing the iron (II) oxalate crystals to metallic iron and, in such instances, the recovery gas introduced into the recovery reactor 108 may include hydrogen such that the recovery reactor 108 has a reducing environment that supports reduction of the iron (II) oxalate crystals to metallic iron. In some implementations, the particles of metallic iron may be formed from agglomerations of iron (II) oxalate crystals (e.g., with the agglomerations including a binder), as may be used for producing the metallic iron as particles within a predetermined size range.

As an additional or alternative example, recovering the iron-containing product from iron (II) oxalate crystals in the recovery reactor 108 may include decomposing the iron (II) oxalate crystals to iron (II) dioxide. In such instances, the environment gas introduced into the recovery reactor 108 may be one or more inert gases (e.g., nitrogen and/or argon) such that the recovery reactor 108 has an inert environment that supports decomposition of the iron (II) oxalate crystals to iron (II) dioxide.

The foregoing method descriptions and the process flow diagrams are provided merely as illustrative examples and are not intended to require or imply that the steps of various embodiments should be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular. Herein, “about” may refer to a range of +/−5%.

Further, any step of any embodiment described herein can be used in any other embodiment. The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of hydrometallurgical processing, the method comprising:
dissolving at least one component of an iron-containing feedstock in a lixiviant in a leaching reactor, the at least one component dissolved in the lixiviant forming a leaching slurry, the lixiviant including oxalate and an iron-complexing additive;
separating the leaching slurry into insoluble solids and a pregnant leaching solution;
precipitating iron (II) oxalate crystals from the pregnant leaching solution in a precipitation reactor; and
recovering an iron-containing product from the iron (II) oxalate crystals in a recovery reactor.

2. The method of claim 1, wherein the iron-containing feedstock includes iron-bearing tailing, iron-bearing residue, mill scale, or a combination thereof.

3. The method of claim 1, wherein the iron-containing feedstock includes iron ore.

4. The method of claim 1, wherein the iron-containing feedstock includes iron oxide, iron hydroxide, iron oxyhydroxide, metallic iron, or a combination thereof.

5. The method of claim 1, wherein the oxalate includes oxalic acid.

6. The method of claim 1, wherein the oxalate has a concentration of greater than 1 mol/L in the lixiviant and separating the leaching slurry into the insoluble solids and the pregnant leaching solution includes filtering the leaching slurry at a temperature of 65° C.-100° C. and then diluting the pregnant leaching solution.

7. The method of claim 1, wherein the oxalate includes salt of oxalic acid.

8. The method of claim 1, wherein dissolving the at least one component of the iron-containing feedstock in the lixiviant includes maintaining oxidation-reduction potential of the lixiviant within a predetermined range in the leaching reactor.

9. The method of claim 1, wherein dissolving the at least one component of the iron-containing feedstock in the lixiviant includes introducing scrap iron into the leaching reactor.

10. The method of claim 1, wherein dissolving the at least one component of the iron-containing feedstock in the lixiviant includes mixing the iron-containing feedstock and the lixiviant together in the leaching reactor.

11. The method of claim 1, wherein the oxalate in the lixiviant is 10-35 percent above a stoichiometric amount of the oxalate with respect to iron in the iron-containing feedstock.

12. The method of claim 1, wherein dissolving the at least one component of the iron-containing feedstock includes reducing the iron-containing feedstock to a particle size distribution with d80 about 20 microns and less than about 150 microns.

13. The method of claim 1, wherein dissolving the at least one component of the iron-containing feedstock includes oxidizing one or more components of the iron-containing feedstock.

14. The method of claim 1, wherein the at least one component of the iron-containing feedstock is dissolved in the lixiviant at a temperature greater than about 70° C. and less than about 100° C.

15. The method of claim 1, wherein dissolving the at least one component of the iron-containing feedstock in the lixiviant includes shielding penetration of visible light and/or ultraviolet light into the leaching reactor.

16. The method of claim 1, wherein dissolving the at least one component of the iron-containing feedstock includes introducing scrap iron and/or an iron (II) salt to the iron-containing feedstock.

17. The method of claim 1, wherein separating the leaching slurry into the insoluble solids and the pregnant leaching solution includes pumping the leaching slurry from the leaching reactor toward the precipitation reactor.

18. The method of claim 1, wherein precipitating iron (II) oxalate crystals includes controlling pH of the pregnant leaching solution to a range favoring iron (II) oxalate precipitation.

19. The method of claim 1, wherein recovering the iron-containing product from the iron (II) oxalate crystals is carried out at a temperature of greater than about 400° C. and less than about 800° C. at atmospheric pressure in the recovery reactor.

20. The method of claim 1, further comprising forming the oxalate using biofermentation of glucose, synthesis from carbon dioxide and hydrogen, or a combination thereof.
